(19) United States
(12) Patent Application Publication
(10) Pub. No.: US 2022/0287481 A1
(43) Pub. Date: Sep. 15, 2022

(54) Method and system for modularly displaying artistic works

(71) Applicant: Elijah A. Mzilikaze, Miami, FL (US)

(72) Inventor: Elijah A. Mzilikaze, Miami, FL (US)

(21) Appl. No.: 17/199,811

(22) Filed: Mar. 12, 2021

(51) Int. Cl. A47G 1/06

(52) U.S. Cl. CPC A47G 1/065; A47G 1/0633; A47G 1/0638

(57) ABSTRACT

modular artwork display assembly formed of multiple display modules which are, themselves, translucent pockets for holding viewable sheets of artwork and that interconnect to each other along their respective perimeters.

### BACKGROUND

The present invention generally relates to art displaying, and it is specifically directed to a method and system for producing a modifiable, planar display of an assortment of works of art.

In the world of street art, a quite popular artform has emerged in which several drawings done on at least substantially blank sticker substrates are plastered onto a display surface to create a collective visual display. This “sticker slap,” as it is commonly referred to, often involves the use the LABEL 228s provided by the U.S. Postal Service, due to the LABEL 228 being available free of charge and in great abundance at post offices around America, and it has a predominantly white writing surface that suitably serves as a drawing canvas. However, other stickers possessing substantially, or entirely, blank writing surfaces are often used as well.

In sticker slap art, the stickers are artistically decorated with colored markers, pencils, or acrylic paints, and several of them are, then, adjacently plastered onto a display surface of some sort to create a collective display. Some such displays may have a particular theme, and the individual stickers may be arranged to produce a desired overall impression or convey a decipherable message, while other displays may simply be formed over time as the result of the uncoordinated sticker art contributions of multiple artists and have no apparent theme whatsoever. In fact, slap art displays can function as merely informal exhibits for any number of artists that contribute any number of the individual drawings that constitute them. In any case, these displays are often formed on building exterior or interior walls or anywhere that that they will be visible to passersby, and they are increasingly popular with street artists.

However, the present inventor recognizes a couple of limitations associated with the way that sticker slap art is conventionally practiced. First, in cases where the stickers are adhesively applied to the display surface, the arrangement of the stickers is permanent and cannot be modified to, say, replace certain previously posted stickers with others that are either considered to be better works of art or more conducive to creating a desired overall impression. One may even occasionally wish to simply rearrange the same drawings without even introducing any new ones to the collection, but that cannot be done to adhesively affixed stickers. Plus, if the display surface is a wall or other fixture, the composite display is effectively stuck in place and cannot be moved to other locations to be exposed to different audiences.

Second, when displays are made up of stickers that are not actually adhered to the display surface (i.e., the adhesive papers are not peeled from their non-stick substrate papers, and the stickers are either laid together atop a horizontal surface or are pinned onto a vertical display surface), stickers can easily be nefariously removed or, if they are simply resting on a surface, can be inadvertently bumped or air blown out of place.

Consequently, the present inventor recognizes a need to be able to display these kinds of works of art in a way that renders them removable, transportable, and easily rearrangeable, yet relatively secure. The present modular display system and method for its use in the context of sticker slap art fulfills this outstanding need.

### SUMMARY

It is an object of the present invention to provide a system for displaying a multitude of sheets of artwork—be they artistically decorated LABEL 228 stickers or any other planar displays of design art—in substantially adjacent fashion and in a manner that allows the sheets to be rearranged relative to each other. In one aspect of the inventive display system, it is formed by several like display modules which are transparent open envelopes, or pockets, for retaining and enabling the viewing of sheet material. Each pocket is formed by a transparent front sheet (typically, a transparent plastic film) having attached to similarly shaped, but slightly smaller, rear sheet which may or may not also be transparent. Where the rear sheet is rectangular, its two side edges and bottom edge are affixed to the front sheet, but its top edge is not, leaving an opening into which sheet material, such as a LABEL 228, can be inserted and retained with its decorated side facing and viewable through the front sheet.

In another aspect of the present system, the edges of each of these display modules are connectable to the edges of other such modules so that the drawings inserted within them can be displayed in laterally and/or longitudinally adjacent fashion. More specifically, along each of the upper, lower, right, and left perimeters of each of the pocket front sheets are the male or female components of a ziplock, press and seal, zipper, slider, button, or hook and loop type fastening mechanism which enable a given pocket's front sheet perimeter to be fastened to the opposing perimeter of another pocket's front sheet which has cooperating fastener components positioned along it. Thus, each display pocket functions as a module within a larger system of connected modules that can be expanded or contracted in any direction by simply connecting or disconnecting certain pockets to each other.

It is another object of the present invention to create a method for employing this modular system in the context of displaying a collage of sheets of art. In another aspect of the invention, LABEL 228s or other substrates bearing artistic designs are to be inserted into multiple of the described display pockets, and those pockets are to be connected to each other, edge-to-edge (i.e., lower perimeters connected to upper perimeters of vertically adjacent pockets, and right perimeters connected to left perimeters of laterally adjacent pockets), to form a composite display. That assembly of connected pockets can, then, be non-permanently secured (say, with thumbtacks) to a tabletop, wall, corkboard or other suitable horizontal or vertical display surface. And because the individual pocket openings are located behind the front sheets, the inserted artworks cannot be easily removed from them without, first, unsecuring the assembly and lifting it away from the display surface to gain access to the pocket openings. Still, the assembly can be unsecured from the display surface in order that art pieces be rearranged as desired, or so that the entire display assembly may be transported elsewhere.

### BRIEF DESCRIPTION OF THE DRAWINGS

FIG. 1 is a perspective view of an empty display module in accordance with the present invention; and

FIG. 2 is an elevational view of an assembly of art-filled display modules in accordance with the present invention.

### DETAILED DESCRIPTION OF THE PREFERRED EMBODIMENTS

This disclosure, as defined by the claims that follow, relates to a way to display sticker slap art—or any plurality of art works done on sheet material—modularly such that the individual art works are rearrangeable, relative to each other, and are individually and collectively transportable.

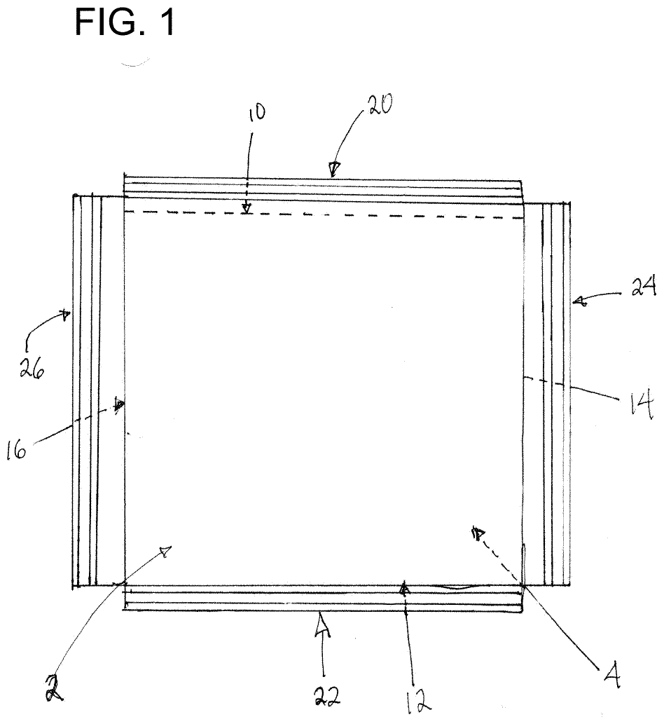

As can be seen in FIG. 1, the individual artwork display module 1 of the present invention is formed by two sheets of material: (1) a translucent front sheet 2 (“front” in that its position, relative to the other sheet, is facing the inserted art observer) overlaying (2) a rear sheet 4—which may or may not be also translucent—that is securely attached to the front sheet 2 along some, but not all, of the rear sheet's edges so that the two module sheets form an open pocket inside which sheet material, like decorated LABEL 228s, can be inserted. For example, in embodiments where the rear sheet 4 is rectangular, it is anticipated that its right edge 14, left edge 16 and bottom edge 12 are all affixed to the front sheet 2, while its top edge 10 is not. However, alternatively, the rear sheet's top edge 10, bottom edge 12 and either left 16 or right edge 14 could be sealed to the front sheet 2 while its other edge (right or left) is not.

Nevertheless, the single module 1 has connecting elements disposed along (at or closely adjacent to) its perimeter edges (typically, along the four edges of the front sheet 2, specifically, which extend beyond the main body of that sheet). These connecting elements may be the male of female component(s) of a zip-lock fastener (meaning a groove and ridge type of sealing arrangement), press and seal fastener, zipper, slider fastener, button, or hook and loop fastener or other fastening means. In a preferred embodiment of the present module, the male components (ridges) of zip-lock fasteners run along its top 20 and right perimeters 24, while the female components (grooves) of the same run along its bottom 22 and left 26 perimeters. This enables the top perimeter 20 of this module to be connected to the bottom perimeter of another identically configured one, its right perimeter 24 to be connected to the left perimeter of yet another, and so forth.

It should be noted that it is anticipated that the front sheet of the module will be the same shape as, but slightly larger than, the rear sheet and that the connecting elements will be disposed along the edges of that larger front sheet (which constitute the perimeters of the overall module). However, this size relationship could be reversed, and the connecting elements could be situated along the rear sheet, instead, with the front sheet having one edge that is not secured to the rear sheet to form a pocket that faces the art viewer.

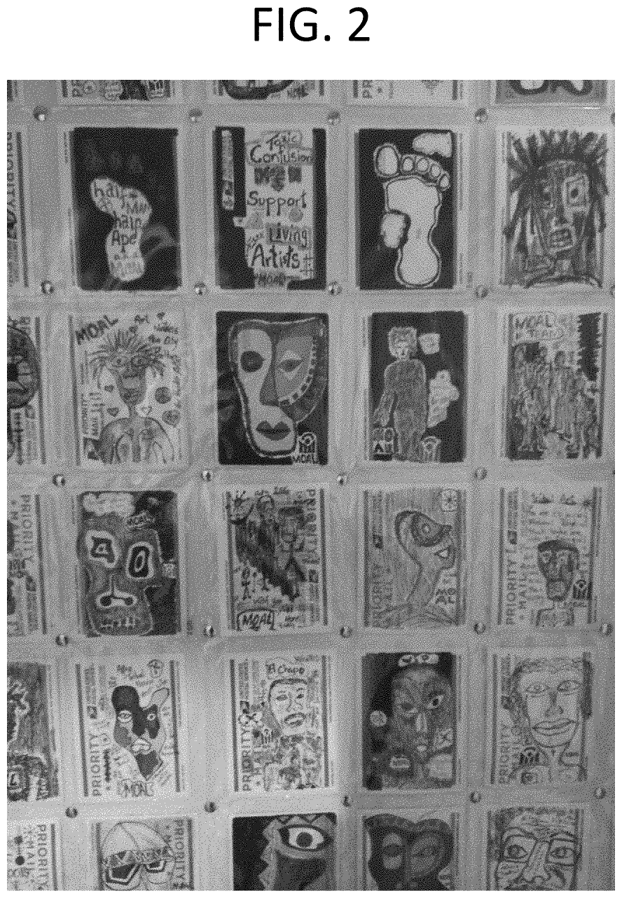

When multiple modules are filled with artwork and are interconnected, it produces a composite display sheet, as shown in FIG. 2, that can be pinned or otherwise attached to a display surface for viewing of the assembly.

1. (canceled)

2. (canceled)

3. (canceled)

4. (canceled)

5. An artwork display module comprising:
a transparent front sheet and a rear sheet forming an open pocket for inserting artistic works into by virtue of some of, but not all, the edges of one such sheet being affixed to the other such sheet; and
wherein zippers are disposed along its perimeter for connecting the display module to other display modules.

6. (canceled)

7. The display module of claim 5, wherein an artistic work is inserted therewithin.

8. The display module of claim 7, wherein said artistic work comprises an artistically decorated LABEL 228.

9. A modular artwork display assembly comprising a plurality of display modules that are detachably interconnected, along their respective perimeters, to form a composite display sheet, wherein a display module comprises:
a transparent front sheet and a rear sheet forming an open pocket for inserting artistic works into by virtue of some of, but not all, the edges of one such sheet being affixed to the other such sheet; and
wherein connecting elements, for connecting the display module to other such display modules, are disposed along its perimeter and are components of at least one of:
zippers or hook and loop fasteners.

10. (canceled)

11. The modular artwork display assembly of claim 9, wherein artistic works are inserted within said display modules.

12. The modular artwork display assembly of claim 11, wherein said artistic works comprise artistically decorated LABEL 228s.

13. The display module of claim 5, wherein said zippers are press and seal fasteners

14. The display module of claim 5, wherein said zippers are zip-lock fasteners.

15. The display module of claim 5, wherein said zippers are slider fasteners.

16. An artwork display module comprising:
a transparent front sheet and a rear sheet forming an open pocket for inserting artistic works into by virtue of some of, but not all, the edges of one such sheet being affixed to the other such sheet; and
wherein hook and loop fasteners are disposed along its perimeter for connecting the display module to other display modules.

17. The display module of claim 16, wherein an artistic work is inserted therewithin.

18. The display module of claim 17, wherein said artistic work comprises an artistically decorated LABEL 228.
